(19) United States
(12) Patent Application Publication
(10) Pub. No.: US 2013/0041826 A1
(43) Pub. Date: Feb. 14, 2013

(54) Content Purchaser Distribution Payment System

(71) Applicant: Vringo, Inc., New York, NY (US)

(72) Inventors: Andrew K. LANG, New York, NY (US); Steven Spencer, New York, NY (US); Heikki Kokkinen, Helsinki (FI)

(73) Assignee: Vringo, Inc., New York, NY (US)

(21) Appl. No.: 13/653,319

(22) Filed: Oct. 16, 2012

Related U.S. Application Data
(63) Continuation-in-part of application No. 11/734,863, filed on Apr. 13, 2007.

(51) Int. Cl. G06Q 20/40

(52) U.S. Cl. 705/44

(57) ABSTRACT

A system and method for authorizing access to digital content includes encoding, with a processor, a digital content with a unique identifier. The digital content is delivered to an authorized user. A query is received from a second user and it is determined if the second user is the authorized user. If the second user is not an authorized user one of a payment authorization for the digital content is received from either the authorized user or the second user and an instruction is received to disable the digital content.

### BACKGROUND OF THE INVENTION

1. Cross Reference to Related Applications

This application is a continuation-in-part of U.S. patent application Ser. No. 11/734,863, which was filed with the U.S. Patent and Trademark Office on Apr. 13, 2007.

### FIELD OF THE INVENTION

The present invention relates to content and, more particularly, to techniques for managing sharing, payment and/or rights of distributed content.

### BACKGROUND

Content, such as television broadcasts, Internet content, audio content, video content, software and in general content stored on prerecorded media are valuable commodities in the current economy. Presently, content may be provided from a content distributor to particular devices in various formats. Content may be delivered in an unprotected or encrypted manner, such as through peer-to-peer (p2p) file sharing networks. It is estimated that 50% to 80% of traffic in many global Internet networks is p2p file-sharing, and quite often such content is copyrighted content. As such, the sharing and downloading of copyrighted content may results in various legal issues.

The current copyright protection mechanisms can fall into three categories: (1) no copyright protection (which is by far the most popular currently), (2) digital rights management (DRM) technologies to protect copyrighted content (e.g., Musiikkilataamo—online Finnish music shop, iTunes), or (3) access control based copyright protection (e.g., eMusic). These all suffer in one way or another. For example, without any protection, copyrighted content may be illegally copied which may be bad for the user and may result in a loss of income for the copyright owner; DRM protected content (or files) are not necessarily accessible or playable on all types of user devices; and access control based protection affords a good solution but (a) a large amount of content is still shared without paying the copyright owner and (b) the available content is limited to the selection of the provider.

The problem of sharing unlicensed digital content has existed for over 15 years. While there have been many technological and legal attempts to curtail the spread of unlicensed content, services flourish and provide a quick and easy way to share all forms of digital content.

Thus, there is currently a need for alternative techniques or approaches for managing and generating revenue from distributed content that may be acceptable to both consumers and content owners.

### SUMMARY

In accordance with an embodiment, a method, apparatus or tangible computer medium (which stores computer executable code or program code) performs or facilitates: determining one or more aspects of an unauthorized copy of electronic content accessible to or through a user device; and conducting a transaction between the user device and a legitimizing party to legitimize the electronic content in view of the determined aspect(s). The electronic content may be unsecured copyrighted content.

In another exemplary embodiment, the conducting operation may involve: conducting a payment transaction with a party authorized to legitimize content in order to pay a price or cost for legitimizing the electronic content in view of the determined one or more aspects; and acknowledging that the content is legitimate.

According to one embodiment of the invention, a digital file is encoded with the license holders ID, preferably within the digital content payload. As the digital file is accessed, the ID is checked against the ID associated with a player. It should be noted that one or more players could be associated with an ID. The authenticity of a license for the digital file and/or a specific player is determined. Unauthorized play attempts are transmitted to a centralized server. The original licensed user is charged for permitting unauthorized sharing, this charge, and payment, allows the user to legally share their content by paying the additional license fees. Digital files include one or more of music, video, text, books, applications, software, etc., and players include one or more of a personal computer, a tablet computer, a smartphone, a cable box, an mp3 player, and the like.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The various exemplary embodiments will be described with reference to the accompanying drawings, wherein:

FIG. 1 is a diagram of an exemplary operational environment in accordance with an embodiment;

FIG. 2 is a diagram of an exemplary operational environment in accordance with another embodiment;

FIG. 3 is an exemplary pricing process in accordance with an embodiment;

FIGS. 4A, 4B, 4C, 4D, 4E, and 4F are exemplary interfaces in accordance with an embodiment;

FIG. 5 is a flowchart of an exemplary process by which a content may be legitimized after the content has been transferred or copied by a user or the like in accordance with an embodiment;

FIG. 6 is a flowchart of an exemplary process by which content may be legitimized after the content has been transferred or copied by a user or the like in accordance with another embodiment;

FIGS. 7A and 7B are flowcharts of exemplary processes by which aspects of a content or pricing information for content may be obtained, generated, transmitted and/or received between one or more parties involved in the post legitimization of content in accordance with an embodiment;

FIG. 8 is a block diagram of an exemplary computer system in accordance with an embodiment;

FIG. 9 is a block diagram of an exemplary removable or portable memory device or unit in accordance with an embodiment;

FIG. 10 is a flowchart for a method to mark for copyrighted digital files; and

FIG. 11 is a flowchart or a method to pay for copyrighted digital files.

### DETAILED DESCRIPTION OF VARIOUS EMBODIMENTS

### I. Operational Environment

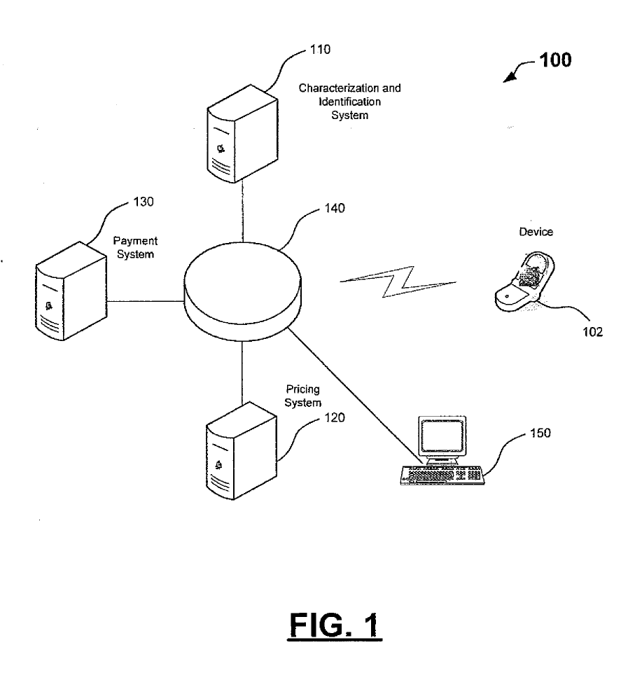

Before describing the various embodiments in detail, it is helpful to describe an environment in which one or more of the exemplary embodiments may be used. Accordingly, FIG. 1 is a diagram of an operational environment 100 where electronic or digital content, such as for example maintained and accessible by a user, may be legitimized according to an embodiment. This environment includes a user device 102 (e.g., a terminal with content and client software), a Characterization and Identification system 110, a Pricing system 120, a Payment system 130 which may all be coupled or able to communication across one or more networks 140. This environment also includes a terminal 150 which may provide an access point for communications with systems 110, 120, 130 or be configured to access (e.g., read, write, modify, update, etc.) content on device 102 and to implement a post legitimization process and service described herein.

In this example, a user or the like through a device (e.g., device 102) can legitimize content thereon, such as content which is accessible and/or is an unauthorized copy, after the content is or has been obtained from some source, e.g., legally or illegally. The user may have obtained the content through file-sharing such as through a p2p network, by burning or obtaining a copy from another person, by obtaining a copy through the Internet or a web site, or through some other channel, and so forth. The user can then at any time thereafter (e.g., immediately after transfer or several years later, etc.) conduct a transaction to legitimize the obtained content. This may involve paying an entity or agent of the entity with legal rights to license or distribute the content (e.g., content provider or owner, their agents, etc.). This may involve for example payment for a license, which may be in various forms, e.g., a lump-sum payment or periodic payment, or so forth. Thereafter, the content is legitimate (e.g., an authorized, legal or licensed copy) and an acknowledgement or record may be provided to the user or associated with the particular copy of the content or maintained by the user or user device. This acknowledgement or record may for example take the form as an item separate from the content (e.g., receipt, email, SMS, etc.) or as modification of the content (e.g., marking, watermark, etc.) or as registration of the particular copy of the content or as a record in a transaction/history log reflecting completion of such a transaction (e.g., payment of license for the content) or etc.

When post legitimization is involved, various approaches may be employed, such as from a selection of the content to be legitimized on or through a user device or other device, to the determination of one or more aspects of the content (e.g., identification and/or characterization of the content), to the determination of a price or cost for legitimizing the content in view of the determined aspect(s), to the payment to legitimize the content and/or to the resulting legitimization of the content.

For example, device 102, such as a user device, may store or maintain a plurality of content. Content from device 102 may be selected manually or automatically for post legitimization. At device 102 or Characterization and Identification system 110, one or more aspects of the content can be recognized or determined. The aspect(s) information may then be provided to a Pricing system 120 which may then determine (or calculate) a price or cost based on the aspect(s) information. This price or cost may be a licensing fee for the content. The price or cost information is provided to device 102 and the user can ascertain whether to pay the price or cost, or negotiate the price or cost with pricing system 120. The user can thereafter decide to pay the price or cost to legitimize the content. This payment transaction may be conducted with Payment system 130. Thereafter, payment system or other systems involved in the post legitimization process or service may provide an acknowledgement or record to the user or user device to reflect that the content is now legitimate, e.g., an authorized, licensed or legal copy, etc. As a further exemplary embodiment, the legitimized content can if desired be encrypted with DRM to provide a layer of protection which may be looked upon favorably by content owners.

These functions or operations, e.g., characterization, identification, and/or pricing/payment can be carried out at a particular device or distributed between devices (or systems), e.g., either the user device, network server(s) or in both of them together. The system or software for implementing such functions and operations may be available as a web service. The software can be downloadable from a server as needed for example as Java script, Java applet, Flash application or generally as a byte or script code executed on a runtime engine. A more detailed discussion of exemplary implementations of each of these functions or operations of post legitimization process or service is provided as follows.

Selection of the content may involve for example manual or automatic selection. For example, a user may identify one or more content to legitimize, such as by traversing a directory, folder, playlist or filelist, etc. Alternatively, the user may set predefined conditions or user settings to implement automatic selection of content to be legitimized. These predefined conditions may include a location of content (e.g., a device, directory, folder, etc.), a predetermined date or time to implement post legitimization of content, a type or format of content (e.g., audio, video, software, mp3, etc.), etc. The selection operation may be performed on or through a user device or through another device or system in combination with a user device. The other device or system may be a kiosk or terminal (e.g., terminal 150) which is able to communicate with the user device or provide an access point for post legitimization of content or is able to access (e.g., read, write, update, etc.) data such as content from the user device and facilitate post legitimization of content.

Determination or recognition of an aspect(s) of content may involve ascertaining or obtaining information or data such as that which identifies (e.g., identification information) or characterizes (e.g., characterization information) the content or other types of information of an aspect or attribute or the like of the content. The identification information may include among other things an identifier of the content, such as a name, a file name, a product identifier or number, title of the content, or any information which identifies the content, etc. The title of content can be recognized for example using several methods which can include fingerprint recognition, rolling average, hashes, filesize-type-date, metadata information, etc. The determination or recognition of an aspect(s) may be implemented on a device other than a user device, by sending information including a copy of a portion or all of the content to be evaluated to the other device or system, e.g., system 110.

The characterization information may include technical aspects (as well as non-technical aspects) of the content which for example may reflect a quality of the content, including for example format, size, length, filesize, compression method, compression level, bitrate, image or screen resolution, mono/stereo/surround, type of data (e.g., audio, video, software, document, etc.), date/time (e.g., create, saved, obtained, modified, published, current, download, etc.), language, geographic region, or other information relating to the nature or quality of the content. As described herein, information regarding an aspect(s) of the content may subsequently be employed to determine a price or cost for legitimizing the content (e.g., licensing fee).

The determination of an aspect(s) may be performed on a user device or other device or system such as a trusted party (e.g., a trusted third party server which may maintain a catalog of aspect-related information for a plurality of content), a characterization and identification system or other devices and systems which operate in a distributed or standalone capacity and participate in the post legitimization process or service described herein. Further, the determination of an aspect may involve parsing, searching and/or extracting data from the content including for example header information or the like and/or from the body of the content, and/or may involve looking up, searching or finding from a repository (or database) of characteristic information for a plurality of content one or more characteristics using identification information of a content, e.g., product identifier (e.g., UPC), file name, title of the content, etc. As will be described below, such a repository or database may be implemented through or maintained by a third party, such as a trusted third party, or through the content provider or its agent. In one exemplary aspect, the post legitimization system may have or provide for direct connection to the repositories or databases of different content providers in order for example to facilitate or make determination or recognition more reliable, or the information in these repositories or databases may be maintained in a single facility or location, e.g., at a trusted third party, for ease of access.

The determined or recognized aspect(s) of content(s) may be determined on one device or system, e.g., the user device, and transmitted to another device or system for further determination of an aspect of the content and/or for determination of price or cost to legitimize the copy of the content obtained by the user or the like. For example, the user device through a user application or client software may control transmission of one or more aspects either one-by-one or all at the same time or in a group (which can be formed in various ways, e.g., [language, content quality, content type, date, name, etc.] or a combination thereof to a pricing system, e.g., pricing system 120. This type of transmission may be performed by other devices or systems as well which may transmit information regarding aspect(s) of content. Further, as desired, the post legitimization system as described herein may add, remove or modify the content (e.g., mp3 file) or content description (e.g., mp3 id tag) or the content information in an identification database (e.g., freeDB) so that it may be easier to identify and characterize a piece of content in the future.

Price or cost evaluation or determination may involve calculation and/or look up from a price repository or database based on for example determined or recognized aspect information for a content. The price evaluation can be implemented using a pre-agreed and configured list of prices versus content, or it can be dynamically determined (or calculated) according to which may be agreed upon between the parties. These algorithms may for example take into account several parameters, such as publisher, quality of content (e.g., see above), publishing date versus current date (or versus download date), availability of the content in other formats, market demand, market supply, market price, and so forth. As such, these parameters may increase or decrease a price or cost for the content and may be weighted differently or the same as desired. For instance, the length of time the user has possessed the content may increase the price or cost.

Price or cost evaluation may involve interaction with the content provider, service provider or content aggregator, or copyright managing organizations (e.g., Teosto) to access the data repositories or databases of one or more of these entities. This may improve for example price definition of the content. For example, the Pricing system 120 or other systems involved in the post legitimization process or service may have direct connection to these entities. As such, pricing information may be accessed from a plurality of entities or such information may reside on a single source, such as a trusted third party.

The determined price or cost information may be communicated, transmitted, or transferred to the user or user device. Additionally, other price information related to similar content, e.g., different quality levels can also be provided. This other price information may be provided along with download links to facilitate purchase of other similar or related content. Other promotional (or advertising) information on related or similar content may also be provided or indicated or informed to the user or user device, e.g., “The users who bought this also bought . . . .” As noted above, if the user wishes to legitimize his or her copy of the electronic content, then the user can purchase or pay for the content, e.g., pay for a license or right to make the copy legitimate (or authorized or legal).

Payment for the content may be implemented in various ways. The user can make a payment in any way acceptable to a payment system, e.g., payment system 130. For example, the payment system may accept payment using credit card, bank card, bank automat card, Pre-paid card, micro-payment systems, billing, account, bank account transfer, Western bank transaction, cheque, other accounts such as through other bills like mobile phone bill, bank online payment systems such as Nordea Solo, Paypal, etc., and so forth. As a further example, a payment aggregator can be used. The payment may not go through the user and a particular payment facility or system, e.g., a credit card such as Visa when. it is used for the transaction, instead there may be a payment aggregator which provides the payment service for the service provider. As such, the service provider may not need to have contracts with all possible payment systems, but rather can have one payment related contract with the aggregator while still allowing users to pay using different forms of payment.

When payment is carried out or completed, an acknowledgement or record can be electronically generated or implemented. For example, Payment system 130 or other systems involved in the post legitimization process or service may transmit a receipt to the user via email, SMS, in paper format or through other bills such as mobile phone bill/receipt. Other acknowledgement or record implementations may also be provided, such as registration of the content, a record on a transaction/purchase history or log for the seller or the consumer (e.g., user) and so forth. For example, a user application or client software may include a purchase management system which can create and maintain such a history or log of purchases or payments. As another example, payment system 130 or other systems involved in the post legitimization process or service may alter the content or information associated therewith by for example marking or watermarking the content to reflect that the copy of the content is legitimate, or may add other information such as a payment unique number to the content, e.g., either for example a metadata section or mixed in the content so that it does not lower user perception of the value of the content. With regards to the payment unique number, this number can afterwards be used as verification in combination with or in view of a receipt or other purchase transaction records. This information can also be used by the user application or client software, for example, to search content that has or has not been paid for. For instance, this may be employed as part of the selection process to determine which content to or not to legitimize.

Employing a post legitimization process or service may provide among other things various benefits or advantages versus existing solutions, as noted above. For example, as compared to the typical no protection scenario, the content may be legitimized (e.g., made legal) and the owner of the content (e.g., copyright owner) can obtain revenue, income or money. As compared to DRM, the content can be accessible or used in all devices (e.g., not limited), revenue or income can be obtained from the user from earlier downloaded content, and revenue or income can be obtained from content that would be distributed anyway without copyright or protection. As compared to access control techniques, the content may not be limited to the content selection of a specific content provider, the post legitimization approach covers at least in theory all content in the p2p networks distributed earlier, currently or in the future, and it may not be necessary to run content distribution server.

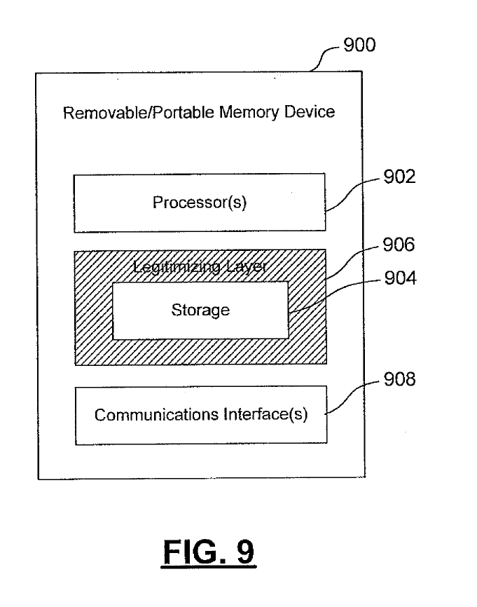

Turning back to FIG. 1, device 102 may be a user device, such as a computer, a mobile communications device or terminal (e.g., mobile phone, laptop, personal digital assistance (PDA), etc.), a portable memory device (e.g., Secure Memory Card (SMC), Smart Card, Multi Media Card (MMC), Secure Digital (SD), USB Flash Drive (USD), etc.), or any computer or processor based device with memory capacity. In various exemplary embodiments, device 102 may have content stored thereon and may also include client software to implement or facilitate implementation of various exemplary post legitimization processes described herein. The client software (or user application) may be configured to allow a user to initiate and conduct a transaction or process to legitimize content. This may include to select manually or automatically content (e.g., unauthorized and accessible content) to be legitimized, to determine (or obtain) one or more aspects of the content including obtaining such information from another party such as a trusted party, to determine (or obtain) a price or cost for the content, to negotiate the price or cost with the legitimizing party, and/or to receive or maintain a record or acknowledgement for the legitimization of the content, and so forth. Exemplary components of user device 102 are described below with reference to FIG. 8 and/or FIG. 9.

One or more of networks 140 may be a private or public network, and/or wireline (e.g., cable, optical, twisted pair, etc.) or wireless cellular networks. In addition, one or more of these networks may be short-range proximity networks, which employ technology, such as Bluetooth or Ultra-Wideband (UWB) or etc. Accordingly, device 102 may be implemented as a mobile device such as a mobile phone, mobile personal digital assistant (PDA), mobile computer, mobile or portable memory, etc. Network(s) 140 may include a packet-based network, such as the Internet.

Characterization and Identification system 110, Pricing system 120, and Payment system 130 may be computers such as a server which implement server applications or server software to perform functions and operations of the exemplary post legitimization processes described herein. For example, system 110 can be configured to determine aspects of content, e.g., characterize or identify content such as described herein; system 120 can be configured to determine price or cost for legitimizing content such as described herein; and system 130 can be configured to conduct payment transaction for content as described herein. These systems 110, 120 and 130 may also implement the functions and operations to acknowledge or make a record of the legitimization of content, e.g., payment is complete and license is obtained. Systems 110, 120 and 130 may take the form or include components such as described below with reference to FIG. 8 and/or FIG. 9.

The above simply provides various exemplary functions and operations which may be involved in the exemplary post legitimization processes described herein.

Although FIG. 1 shows a plurality of systems 110, 120 and 130, the functions and operations performed by these systems may be distributed in other ways or implemented on a single device or system or implemented on a standalone or networked device or system. Further, the post legitimization process or service may be accessed through a terminal or kiosk (e.g., terminal 150, etc.) which serves as an access point for device 102 to access the post legitimization service(s) and/or is able to access (e.g., read, write, update, modify, etc.) data such as content from device 102. This terminal may for example include a media reader and user interface, in which device 102 is for example a portable memory device accessible through the media reader. Along similar lines, an access point such as a wireless access point may be provided at various locations to access post legitimization process or service. Device 102 may access the service through various wireless technologies, including short-range wireless communications including Bluetooth, Ultra-Wide Band (UWB), 802.11(a)-(g) standards, or other forms of communications.

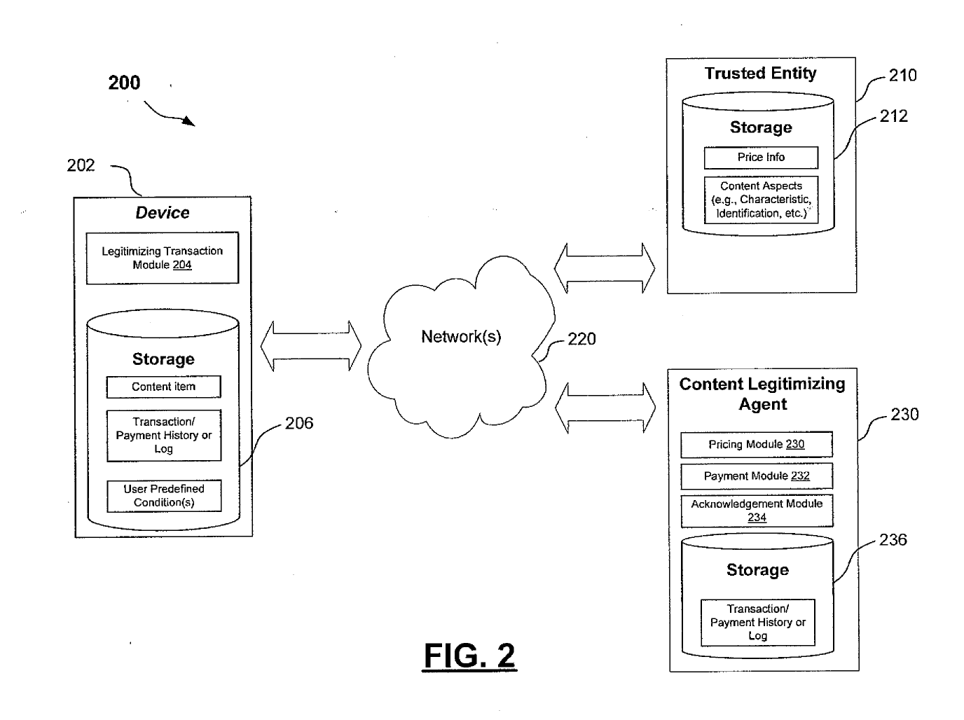

FIG. 2 is a diagram of an exemplary operational environment 200 in accordance with another embodiment. This exemplary environment 200 includes device 202 (e.g., user device), content legitimizing agent 230, trusted entity 210 coupled or able to communicate across network(s) 220. Network 220 may be the same or similar to the network(s) 140 described above with reference to FIG. 1. In this example, various functions and operations of the exemplary post legitimization process or service, as described herein, may be distributed between a content legitimizing agent and trusted entity:

Device 202 may include a legitimizing transaction module 204 and storage device 206 for storing various data and information. Transaction module 204 may be a user application or client software to implement functions and operations for various exemplary post legitimization processes as described herein. This may include management and selection of content to be legitimized, interaction or communications with other systems to implement the exemplary post legitimization processes and maintenance and management of acknowledgements or records reflecting whether content maintained or stored on device 202 is or is not legitimate. Storage device 206 may be a fixed or portable memory media which stores or maintains for example content item(s), transaction/payment history or log, user predefined condition(s) or setting for the selection and other processes in the position legitimization process. Exemplary components of device 202 are described below with reference to FIG. 8 and/or FIG. 9.

Trusted entity 210 may be a computer such as a server implemented by a trusted party or organization. In this example, trusted entity 210 may include a storage device 212 for storing price information and/or content aspect(s) (e.g., characteristics, identification, etc.). The price information may be a compilation of prices for different content and may include different prices depending on various aspects of the content to be priced. The content aspect(s) may be a compilation of attributes (e.g., technical or non-technical) which are known for a particular content. Examples of such aspects have been discussed above and are discussed throughout herein. Accordingly, trusted entity 210 may be employed to obtain pricing or aspect information regarding one or more content such as for use in the exemplary post legitimization processes described herein. Trusted entity 210 may take the form or include components such as described below with reference to FIG. 8 and/or FIG. 9.

Content legitimizing agent 230 may be a computer such as a server operated by an owner or owners of content, provider of content, agent of the owners or providers of content or any party able to legitimize content. Agent 230 may include pricing module 230, payment module 232, acknowledgement module 234 for implementing the pricing, payment, and acknowledgement processes, respectively, of the various exemplary post legitimization processes described herein. Agent 230 may also include a storage 236 which stores or maintains a transaction/payment history or log relating to the payment to legitimize content.

The log or history may also be implemented as or part of a registration process by which the user can register the legitimate content with agent 230. The user can thus obtain acknowledgements or records that content is legitimate from another system. This may be useful in the event that the user loses his or her receipt or the electronic acknowledgement or record is corrupted. Content legitimizing agent 230 may take the form or include components such as described below with reference to FIG. 8 and/or FIG. 9.

Although agent 230 is shown as a standalone unit, it may be part of distributed or networked system employing a plurality of such agents to facilitate the post legitimization of distributed content, such as unauthorized, accessible, unsecured content.

Various forms of digital rights management and licenses keys have been used to limit unauthorized sharing. In one embodiment of the present invention, a copyright holder is compensated for distribution of copyrighted material or digital copies of the copyrighted material are disabled.

In one embodiment, content owners assign a credit card account to each piece of legitimate, licensed content that they own. The owner's ID is encoded, in an encrypted secure manner within the content file. The owners ID is placed in such a manner that it is not possible to remove or alter the identification of the legitimate owner. The manner in which the ID is embedded in the digital content is not discussed in detail as it is beyond the scope of the present invention. The embedding is accomplished using “steganography” and “watermarking” techniques for hiding data in content so it is difficult to remove.

If the user then shares the content in any manner, including but not limited to direct transfer, P2P, and the like, the receiving device detects the original owners ID, transmit that information to a central licensing and charging authority and charges the original owners credit card for the additional license they created by sharing the content with a friend.

One embodiment of the invention is used to chargeback original owners for sharing their content, and legitimately licensing content that has not yet been licensed.

When digital content is purchased in this manner, the purchaser is essentially given a license to redistribute the digital content any way they like, but only if their credit card or other financial accounts can be made to pay for consumption on other devices or by other users. The purchaser may of course elect to not share the content with anyone and avoid financial liability for others' use as well, or only to someone highly trusted not to distribute it further.

### II. Exemplary Operational Scenarios

According to the various exemplary embodiments, a number of exemplary scenarios may be employed to legitimize content maintained and accessible by an entity or party such as a user. In accordance with one exemplary aspect, the legitimizing functions and operations described herein may be employed in a post legitimization scenario relating to copyrighted content which will be described below and referred to by way of non-limiting example as the post-payment copyright (PPC) scenario or system. The PPC system is simply one exemplary system in which copyrighted content or the like may be legitimized after obtaining the content. In this example, the PPC system may involve (1) file selection operation(s) for selecting content to legitimize, (2) characterization and/or identification operation(s) for characterizing or identifying the selected content or aspects (or attributes) thereof, (3) pricing and/or payment operation(s) for pricing the content and/or paying for the content, and/or (4) generating or providing or obtaining acknowledgement or record of payment to reflect that the content is legitimate (e.g., authorized, made legal, licensed, etc.). The PPC system may be implemented for example in the environment of FIG. 1 or FIG. 2, and is discussed in further detail below.

In one embodiment, a user purchases a song or other digital content from an on line store such as iTunes. The store encodes the music with the users ID, for example, the user's Apple ID. If another iTunes compatible device, other than the authorized one(s), detects the song it sends a message to the content provider, Apple in this case, alerting them that a piece of copyrighted content is now in an unlicensed environment.

Upon receiving the notice regarding unauthorized content, Apple, or other content provider, can either automatically charge the original license holder a fee for sharing the content or notify the original owners that the content is in an unlicensed, giving them the option of paying for it, or having the content “disabled” by the unauthorized users iTunes player, or other player.

### A. Post-Payment Copyright (PPC) Scenario

### 1. Introduction

In one exemplary aspect, a post payment system is described herein in which content already obtained or accessible to a user can be legitimized, e.g., licensed or authorized by a party with authority to legitimize content. The content may be copyrighted material, such as video, audio, pictures, programs, software, firmware, and so forth and be illegitimate, e.g., an unauthorized, illegal or unlicensed copy of the content. This legitimization or authorization may be obtained for example through device(s) or system(s) of or operated for or by the owner of the content, the authorized licensor of the content, an organization or trusted party designated to authorize or legitimize content, etc. or agents thereof. In the post-payment copyright environment, the content can be characterized or identified after the transfer or copying of the content rather than by pricing the product before transfer. A PPC system does not have to include any file transfer mechanism. The PPC can include tools for content selection, and content characterization or identification, pricing and payment systems. These functions and operations may be distributed among various devices or systems.

In the copyright area, there are for example two interest groups with partially conflicting interests, e.g., consumers and copyright owners. Consumers generally favor unrestricted use and access to content and thus are not generally in favor of the use of Digital Rights Management (DRM), versus copyright owners who are in favor of such protection. DRM is a generic term covering many different aspects, and may be understood as a system where the content distributor encrypts the content to a format, which cannot be used without decrypting it first. The decryption for example may be carried out in the terminal or device, in which the content is presented.

One alternative to DRM is access control, such as for example provided by eMusic. In the access control systems the content is not encrypted but unauthorized access to the files is prohibited. Buying a CD disk from a music shop is one kind of access control system, as well. The CD music can be ripped to a hard disk without breaking copyright protection systems and the access to the CD in the shop is prohibited until you pay for the CD. In the online shops, a commonly used access control system is a web server with username/password authentication. A consumer advantage of the access control system is that the distribution system does not limit the number of devices, in which the consumer can use the content. A disadvantage for the copyright owner is that the number of further copies or further distribution cannot be controlled by the distribution system. Due to the latter fact many of the large music industry players have not adapted the access control based distribution systems.

The exemplary post-payment copyright system among other things may provide an approach to addressing both consumer and the copyright owner interests. Naturally, it may not solve all the copyright and digital content distribution system problems, but it can provide an enhancement to the existing royalty payment systems. The post-payment copyright system may be configured to work independently of the distribution system. Any distribution system like ripping CDs, web server distribution, local file sharing, peer-to-peer file sharing with any application variant can be supported. A benefit is that the payment can also be independent of the time of the content distribution. The content could have been downloaded in any time in history or the past, and it can be currently downloaded or it can be downloaded in the future. It is of interest to note that the payment system can help or assist a user to pay the royalties or fees for content that has been downloaded in the past.

### 2. File Selection

An exemplary process of post-payment copyright may begin by selecting the content items for consideration in the legitimizing process. It may be important that the user can be ensured that if the user decides not to pay the licenses of any of the selected content, the information will not be stored or delivered further or used as evidence of piracy assaults. One way of assuring this is to use an anonymization server or allow anonymous transaction or communication between the user client and the legitimizing agent or facility, e.g., the other systems or servers of FIG. 1 or FIG. 2. The selection may follow the practice of a file manager software including search, folder selection, selection of group of files, and individual file selection. The file selection does not have to take place with the user interface of the PPC client software, but it can be integrated with or implemented through other software, programs, modules, etc., such as for example a file manager of an operating system, a web browser, or a peer-to-peer file sharing client or so forth.

### 3. Characterization and Identification

The characterization may refer in this example to the evaluation of technical characteristics of the content. The content can on a coarse level be characterized according to its type, such as music, video, or software. The compression methods may affect the value of the content, especially the division between the lossless compression and lossy compression methods. The length, media bitrate, resolution and the file size can also be important properties. The characterization can be used together with the identification of the content to evaluate different prices for different technical quality levels of the same content. Or if, for some reason, the content cannot be identified, the pricing can purely be based on the technical characteristics.

The identification may refer to any type of identifying aspect for a content, e.g., the content can be identified with high confidence. The name and the characteristics of the content can be stored in a database and as a result of the comparison the system can state that the evaluated content and the content or content description in the database match.

In the identification phase, the system can utilize one or several methods to identify the content. One exemplary straightforward approach may be to parse the filename and the metadata like the mp3 ID tag. If the user would like to pay the licensing fee for the content that has been available in the peer-to-peer networks, the file size, length of the content and other characteristic information may match with earlier known content identification.

The system can recognize the title of the content by using several methods which can include fingerprint recognition, rolling average, hashes, filesize-type-date, metadata information, etc. The user may also identify or confirm the information from a shown list.

### 4. Pricing and Payment

For any content that can be paid through the system, an agreement between the operator of the post-payment system and the content owner may exist or be established beforehand. This pricing may also be set by industry standard. The post-payment system pricing can be at the most accurate when each piece of content is priced individually by the content owner, and the post-payment system has direct connection to the database, where the pricing information is maintained. On the contrary, for the unidentified content there might exist a fixed price or default price like $0.99 per song.

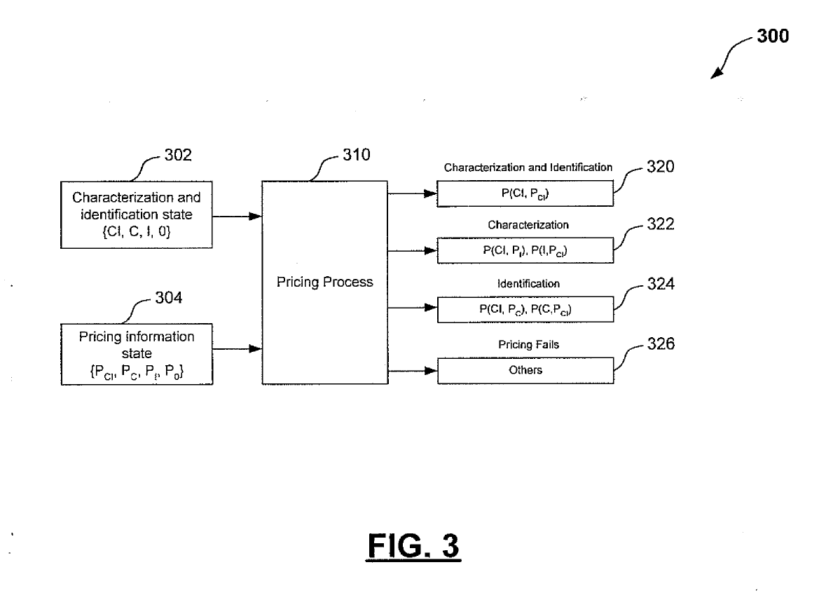

An exemplary diagram of such a pricing process environment or system 300 is described in FIG. 3 and pricing process 310 may employ any number of different input/output states versus that shown in FIG. 3. As shown, in the environment 300, there is a pricing process 310 which may have inputs of characterization and identification state 302 (e.g., {CI, C, I, 0})) or pricing information state 304 (e.g., {P_{CI}, P_{C}, P_{I}, P₀}) and pricing output according to each of state: characterization and identification 320 (e.g., P(CI, P_{CI}))), characterization 322 (e.g., P(CI, P₁), P(I, P_{CI})), identification 324 (e.g., P(CI, P_{C}), P(C, P_{CI})), and/or pricing fails 326 (e.g., others) or default.

For simplification of the problem, in the context of the example in FIG. 3, it can be assumed that the pricing information availability has four states: no pricing information, pricing information available either identification based or characterization based or both. The result of the characterization and identification phase also comes out in similar four states: neither characterization nor identification succeeded, either characterization or identification succeeded, or both characterization and identification failed. From these inputs the pricing process can result successful identification based on characterization, identification or both. If the characterization and identification succeeds and the availability of the pricing information do not map, the pricing process may be configured to fail or operate in a default mode or other mode.

Instead of obtaining information from a copyright content owner, it may be more practical to retrieve the identification and pricing information from an organization, which protects the rights of the media industry or some other trustworthy third party entity or group.

### 5. Acknowledgement or Record of Payment

A challenge in the use of the post-payment copyright system is how to avoid unnecessary payments. Unnecessary payment can occur with copyrighted content obtained or maintained by a user. For example in Finland a person is allowed to rip his or her own CD music disks and listen to that music as mp3 files. The post-payment system is not a DRM system and if the user pays for the content, which is encrypted with DRM, the user still will not be able to open the DRM encryption and use the content. The content, for which the user has already paid the licensing fees with the post-payment system, should in general not be re-paid. The first category may be difficult to recognize or practice. There could be guidance to assist the user to make a decision whether the user is expected to pay a license fee (or other fee) or not. Recognition of the DRM protected content could be a part of the characterization process. The protection against re-payments with the system could happen or be implemented in two exemplary ways. The earlier payments by the user may be stored in the payment system and the system could check the payment history of the user; and the system could warn the user if the same pieces of the content were already paid earlier.

In order to strengthen the capability to recognize the earlier paid content, the post-payment system could alter or modify the content slightly. One place to mark the paid content can be the metadata like mp3 id tags. Storing the customer ID or payment ID in the metadata would be easy to recognize for the software in the future. It would also help to prove that the user has paid the copyrights for that piece of content (or rather license for the copyrighted content), if questioned in the future. One possible issue is that several software applications alter the metadata and, as such, the payment mark may be lost, deleted, or corrupted. Another exemplary method to mark the paid content is to alter the content itself. The system could print a watermark to the content. The watermarks may decrease the quality of the original content, are computationally heavy, and generally disappear when the content is re-encoded. In some situations, it might be possible to replace the content the user has with a content piece from the content provider.

The payment system can be included or excluded from the PPC system. The payment system can be configured to communicate with the rest of the post-payment system. The payment system may include credit card, bank card, bank automat card, Pre-paid cards, micro-payment systems, billing, bank account transfer, Western bank transaction, cheque, bank online payment systems like Nordea Solo, or PayPal. It can also be as an item in other bills such as a mobile phone bill. As in any purchase, the seller may issues a receipt as an acknowledgement or record for the payment or transaction. When a payment has been carried out, the system can issue some form of acknowledgement or record of the payment or transaction, such as a receipt for the user. This receipt may detail various information, such as the content, price, purchase code (unique number in the system database) and date, optionally the person or the customer ID. The receipt can be made or generated electronically by the system and provided in various forms such as email, SMS, paper format or the receipt can appear as an item in other receipts or records like mobile phone bill or receipt. The user application may also include a purchase management system, which contains history of the purchases.

### 6. Exemplary Advantages of the PPC System

As described above, an exemplary PPC system may include software or applications (e.g., client and service software) for a device(s) or system(s) carrying out the file selection, the characterization and identification service, pricing and payment services. The system may be independent of the content delivery system, and it can also be applied for the copyright payments of the content, which has been delivered with any delivery mechanism at any time in the past. Various exemplary advantages may be provided through the PPC system such as, among other things, that the PPC system may provide a consumer friendly environment or system, may be purely based on the consumer initiative rather than forcing the user to any actions, etc. As the system may be configured so as not to contain a traditional DRM system, it may be seen positively by consumer organizations, such as for example those which may oppose a DRM system for ideological or other reasons. The system may be configured not to include any delivery system, and/or not to increase availability of any file in a peer-to-peer file sharing networks or other delivery systems, which may be used for delivery of copyrighted content without licensing fees. The system opens a possibility for licensing income streams, which do not appear to exist currently. Due to the foregoing, even the very conventional copyright owners may benefit and be in favor of such as system.

### III. Exemplary Interfaces

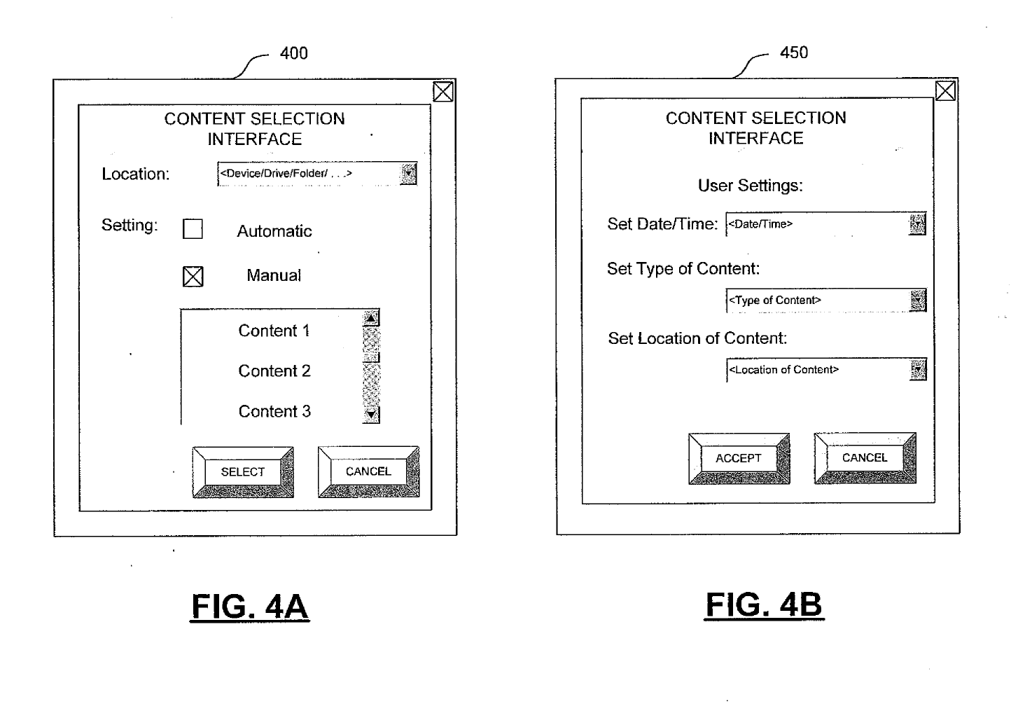

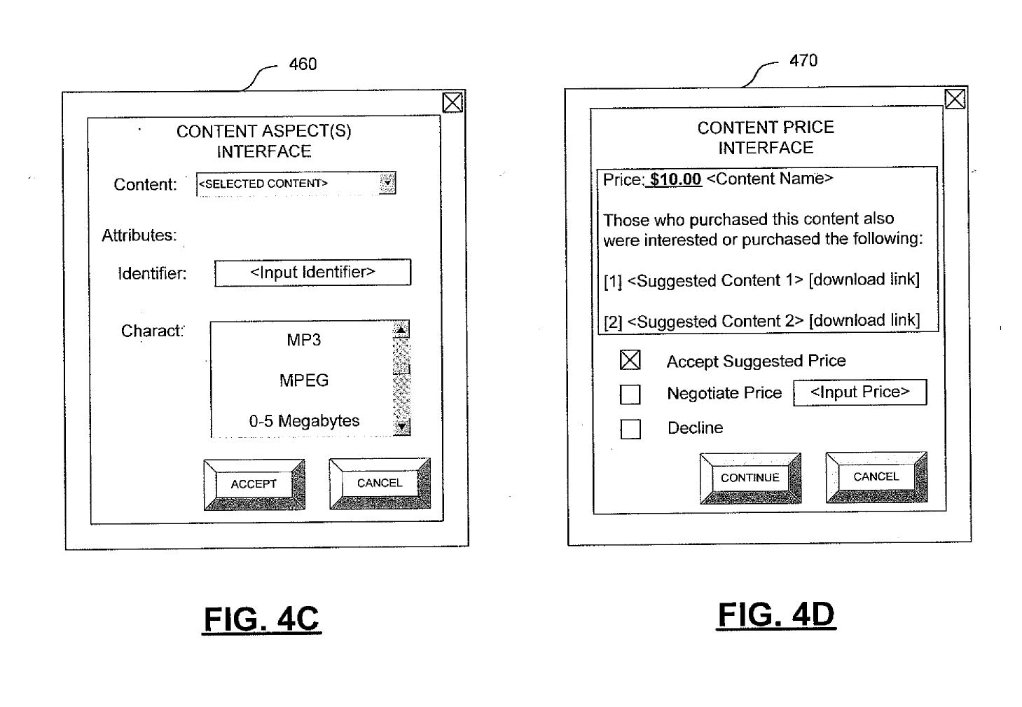

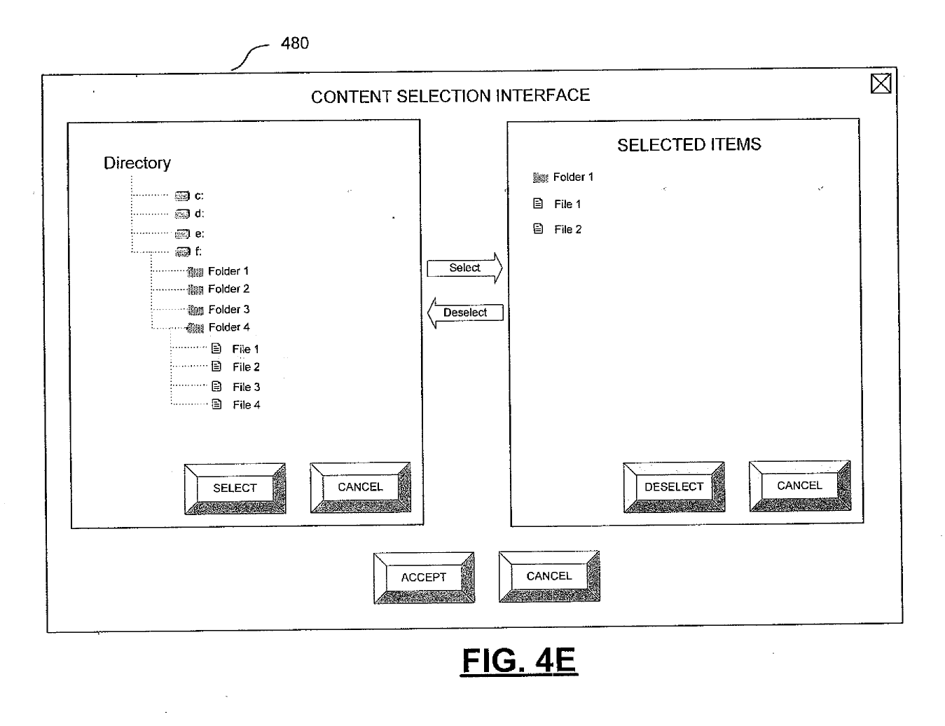

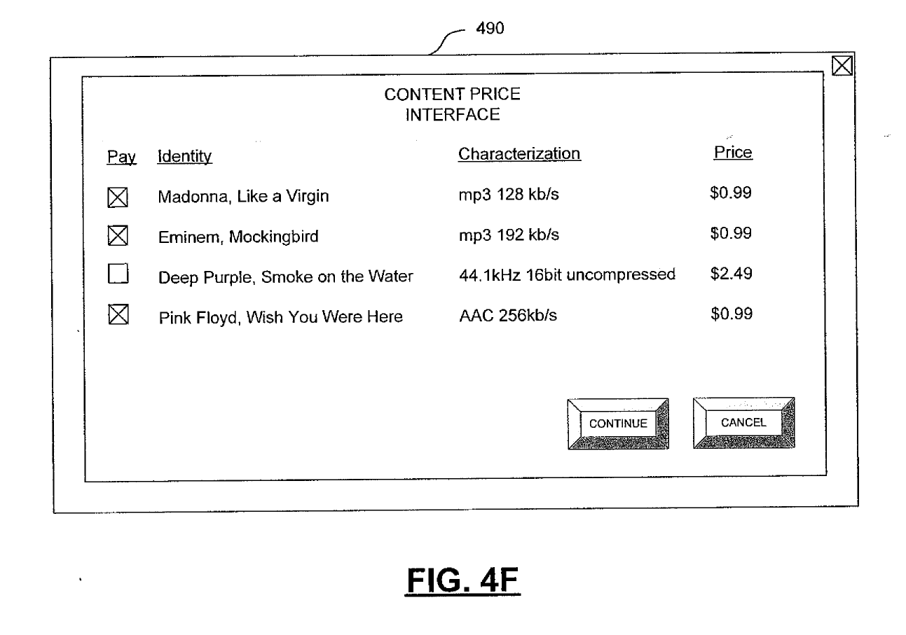

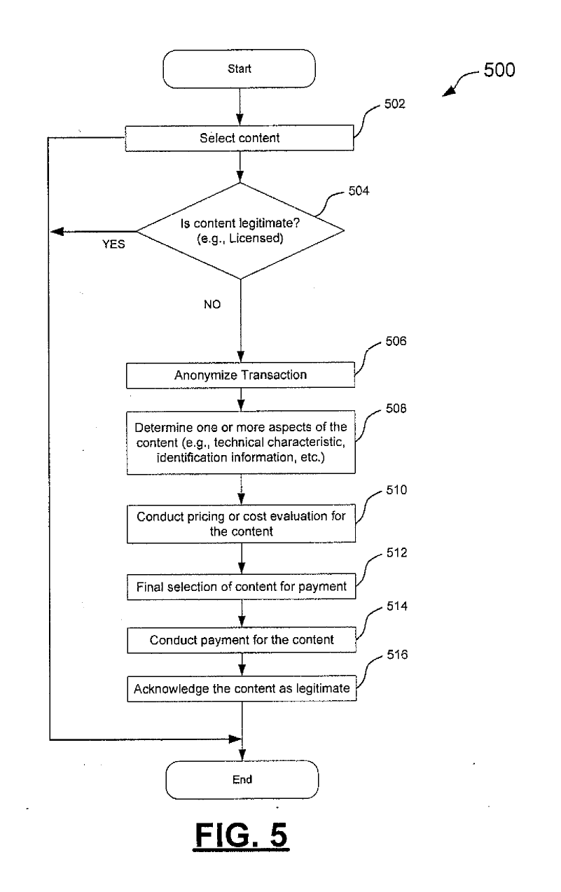

FIGS. 4A, 4B, 4C, 4D, 4E, and 4F are exemplary interfaces 400, 450, 460, 470, 480 and 490 in accordance with various embodiments. In this example, interfaces 400, 450 show exemplary graphical user interfaces for setting the manner in which content is selected for post legitimization, e.g., manually by the user or automatically.

As shown in FIG. 4A, interface 400 provides a plurality of graphical tools to enable a user to select a location (e.g., device, drive, folder, etc.) where content to be legitimized may reside, to select an automatic or manual operation, and in the case of a manual operation to select one or more content (e.g., content 1, etc.) for post legitimization. Another example of a content selection interface is shown in FIG. 4E by way of interface 480. As shown in this further example, the interface may be more like a Windows-based File Manager, such as Windows XP File Manager. Interface 480 may include directory, folders, and files in a tree structure as shown or may include other views such as thumbnail view, tiles, icons, lists, details, etc. Interface 480 may be configured to allow selection of one or more directories, folders, and/or files at a time. For instance, this may involve using the CTRL and Shift key to select multiple items. These selected items (e.g., files, folders, directories, etc.) can be collected in another list, which can be visible for example on a right side of the selection portion of the user interface (or as a separate window) and can also allow for de-selection of an item. The above of simply example, and other graphical tools or aspects of a file manager of Windows or other operating systems may be employed to facilitate selection of items for legitimization.

As shown in FIG. 4B, a user is provided with an interface 450 which allows the user to predefine or set conditions or parameters for the automatic selection of content. In this example, the conditions, parameters or user settings may include among other things date/time (e.g., date or time that content is saved, obtained, modified, created, etc.), type of content (e.g., audio, video, software, document, etc.), location of content (e.g., device, directory, folder, subfolder, etc.), and so forth. These and other conditions or parameters may be predefined or preset to allow for automated selection of content for post legitimization. Other parameters and conditions may include the manner or application being implemented in obtaining content. For example, the selection or even initiation of a post legitimization process may be automatically triggered for certain activities, e.g., p2p file sharing. For example, a user may set parameters or conditions to legitimize content in a folder which receives or contains copied or downloaded files (e.g., content) through p2p network immediately after the file is received or downloaded or at a later time, as desired. Alternatively, instead of automatically initiating the process, these conditions may trigger a notification process by which a user may choose to implement the exemplary post legitimization processes described herein.

FIG. 4C is an exemplary interface 460 by which a user may manually input aspect(s) for a content to be legitimized. As shown, various graphical tools may be provided to allow a user to input or select aspect(s) or to verify such aspect(s) before communicating them to other parties. In this example, the user may input an identifier, e.g., a name, file name, or title of the content, as well as select other aspects of the content, e.g., technical aspects such as a format or size of the content. These are simply provided by way of example, and other aspect(s) as described herein may be available for input of a selection by the user.

FIG. 4D is an exemplary interface 470 by which a user may view a price or cost for a content as well as other pricing information on other related or similar content (e.g., advertising). As shown, graphical tools are provided to allow a user to view a price prior to proceeding with a payment transaction, or to modify and negotiate a price or cost or to decline the transaction. Regarding negotiating a price, a user may for example input a price at which the user is willing to pay. As described herein, other pricing information may also be included, such as advertising for other related or similar content and may provide a means by which the user can purchase or obtain this related or similar content (e.g., download link). For example, the user can select the download link of a desired suggested content (e.g., suggested content 1, etc.) or the like to initiate a transaction to obtain a copy of the suggested content. This transaction may involve the further operations of payment and data transfer of the suggested content to the user device or desired location along with an acknowledgement or record reflecting that the content is legitimate, e.g., an authorized or legal or licensed copy. As another example, FIG. 4F shows an exemplary price interface 490 by which a user may view an identity, characteristics and price information for one or more content items and select an item or items which he or she wishes to purchase and thereby legitimize.

The above is simply provided as an example, and other forms of user interface(s) may be employed to select content(s) to be post legitimized, or to implement other user interactive operations in the process of legitimizing content. The user interfaces in general may be implemented as part of the underlying software or program(s) for legitimizing content or through or in cooperation with a browser, file manager, operating system, and so forth. Interfaces may employ other graphical tools and layouts than shown in the examples of FIGS. 4A through 4F to implement the functions and operations for post legitimization of content.

### IV. Exemplary Processes

FIG. 5 is a flowchart of an exemplary process 500 by which content may be legitimized (e.g., authorized, made legal, licensed, etc.) after the content has been transferred or copied by a user or the like in accordance with an embodiment.

As shown, at step 502, content is selected, such as from a plurality of content on a user device. This may be performed manually or automatically at the user device (e.g., device 102, 202) or through another system (e.g., terminal 150) as described herein.

At step 504, a determination is made whether the content is legitimate, e.g., authorized, legal or licensed copy of the content. This may involve accessing and evaluating transaction/payment history or log regarding the content which may be stored on the user device (e.g., 102, 202) or at a remote location (e.g., 230) or evaluating information embedded in the content (e.g., watermark, mark, code, product identifier, etc.).

At step 506, an anonymizing operation may be initiated or implemented to anonymize any transaction or communications between the user and other parties, e.g., external servers. For example, the anonymization operation may be implemented to ensure that the identity of the user is not provided to the content owner or agent or authority. This may be implemented as an anonymization server through which communications between the parties are conducted. At step 508, one or more aspect(s) of the content are determined. This may involve evaluating content or information associated therewith to determine or recognize aspect(s) or attributes such as characteristic(s) or identification information of the content, for example, as described in the various examples herein. The determination or recognition of an aspect(s) may be implemented on a user device (e.g., device 102, 202) or a device or system (e.g., system 110, 210, 230) other than a user device, by sending information including a copy of a portion or all of the content to be evaluated to the other device or system.

At step 510, a price cost for legitimizing the content may be determined (e.g., calculated, looked up, etc.). The price may be fixed or dynamic depending on aspect(s) of the content, e.g., quality of the content, technical characteristic, non-technical characteristic, identification information, market information, etc. This pricing or cost information may be provided to a user. Other information relating to similar content may also be provided, as described herein, such advertising, download opportunities for related or similar content, etc. The pricing information and other information may be provided to the user. There may also be provided an opportunity for price negotiation thereafter between the user and the pricing system.

At step 512, a final selection of which content(s) to pay for and legitimize may be conducted. For example, a user may be provided with one or more content items for selection, such as shown and described with reference to the example of FIG. 4F. At step 514, in the event the price is acceptable, the user may conduct a payment transaction to legitimize the content(s). As described above, the payment transaction may use various forms of payment (e.g., credit card, etc.) and payment services (e.g., Paypal, bill other accounts such as mobile phone account, etc.).

At step 516, an acknowledgement or record of the completion of the payment transaction reflecting that the content is legitimate is generated and/or provided to the user or user device. This acknowledgement may involve electronic acknowledgement (e.g., receipt), registration of the content with the content provider or owner or a monitoring facility, update of the payment transaction for the specific content on a transaction/payment history or log, mailing a paper acknowledgement to the user and/or altering or modifying the content with watermark, code, mark, product code, license number, etc.

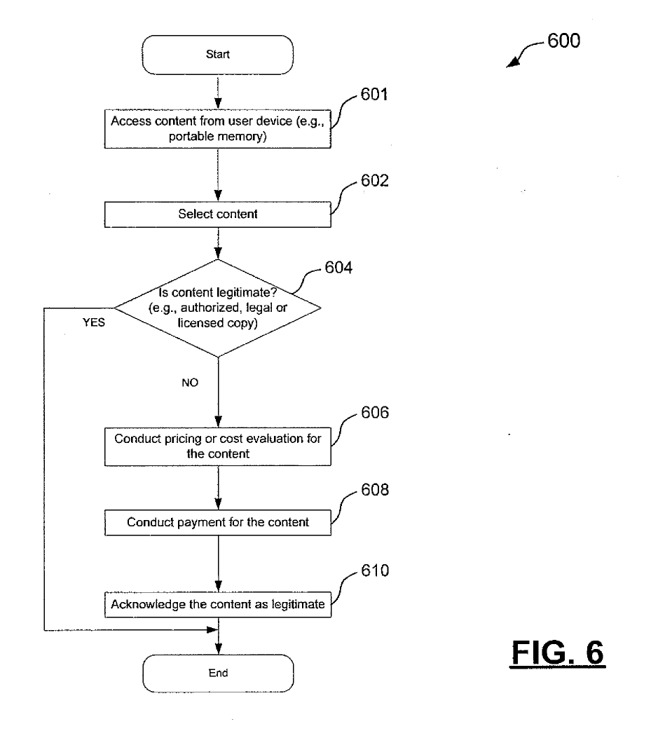

FIG. 6 is a flowchart of an exemplary process 600 by which content may be legitimized (e.g., authorized, made legal, licensed, etc.) after the content has been transferred or copied by a user or the like in accordance with another embodiment. In this exemplary process 600, a post legitimization process or service may be implemented through another device or system, such as for example a non-user device (e.g., terminal 150), in which the user device (e.g., 102 or 202) is a portable memory device storing content.

At step 601, a user may access a post legitimization process or service by using a non-user device or system (e.g., 150) which is able to access data such as content on the user's device, e.g., portable memory. For example, the non-user device may have a media reader to enable access (e.g., read, write, modify, and update to content stored on the user's device, and a user interface through which the user may conduct a post legitimization transaction. Thereafter, the process 600 can proceed with the steps 602, 604, 606, 608 and 610 which may generally be the same or similar to steps 502, 504, 508, 510 and 512 respectively as described above with respect to FIG. 5. As with FIG. 5, the process 600 may also be implemented with an anonymization operation (e.g., step 510 of FIG. 5).

Furthermore, as a further exemplary embodiment, the legitimized content can if desired be encrypted with DRM to provide a layer of protection which may be looked upon favorably by content owners.

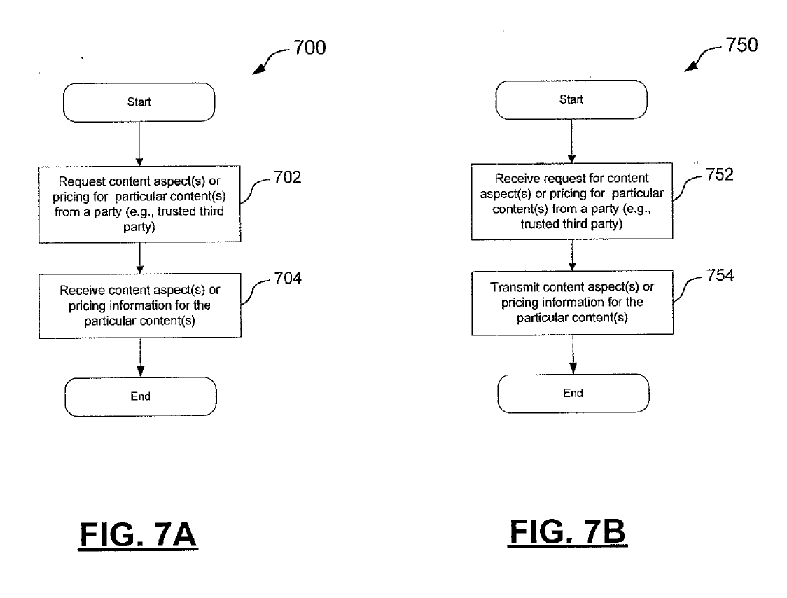

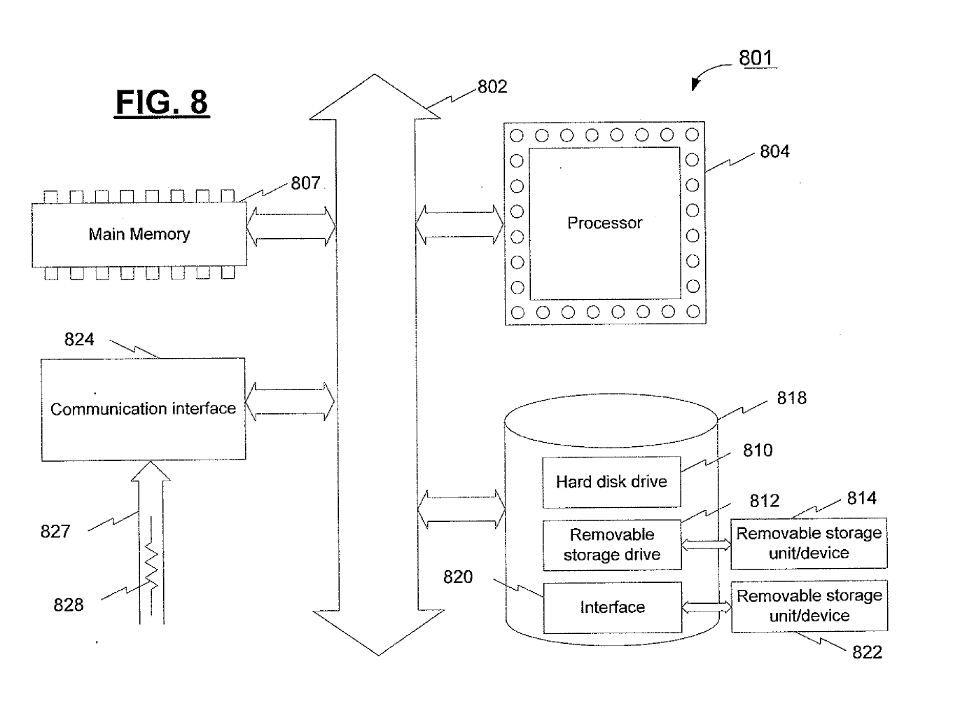

FIGS. 7A and 7B are flowcharts of exemplary processes 700, 750 by which aspects of a content or pricing information for content may be obtained, generated, transmitted, and/or received between one or more parties involved in the legitimization of content in accordance with an embodiment.

As shown in FIG. 7A, a device or system (e.g., 102, 202, 120, 130, 230) may request information regarding aspect(s) or pricing of a particular content(s) from another party at step 702. This party (e.g., 210) may be a trusted entity or party, such as a neutral organization monitoring copyrights or legally protected content. At step 704, the device or system receives information regarding aspect(s) or pricing of the particular content(s). As discussed above, the aspect or pricing information may be employed as part of the post legitimization process or service to legitimize content.

As show in FIG. 7B, a party (e.g., 210) receives a request for information regarding aspect(s) or pricing for a particular content(s) from a device or system (e.g., 102, 202, 120, 130, 230) at step 752. At step 754, the party transmits to the device or system such requested information. As part of this process, the party may determine this information from data repositories or database containing such information for a plurality of content and/or calculate such as for pricing a price based on a pricing algorithm which may take into account various aspects of the content. The party may also obtain such information for other parties or entities.

The various processes described herein in general may be implemented by software including firmware through one or more processors or one or more hardwired or integrated circuits or a combination thereof. The software implementation may take the form of a tangible medium having computer executable code which when read and executed by one or more processors performs the processes described above and herein. These processes are provided as a few examples. The processes are not limited to the described operations or order of operations which can be modified to perform the various functions described herein. For example, anonymization may be initiated or implemented at any time when conducting a transaction or communications with external parties.

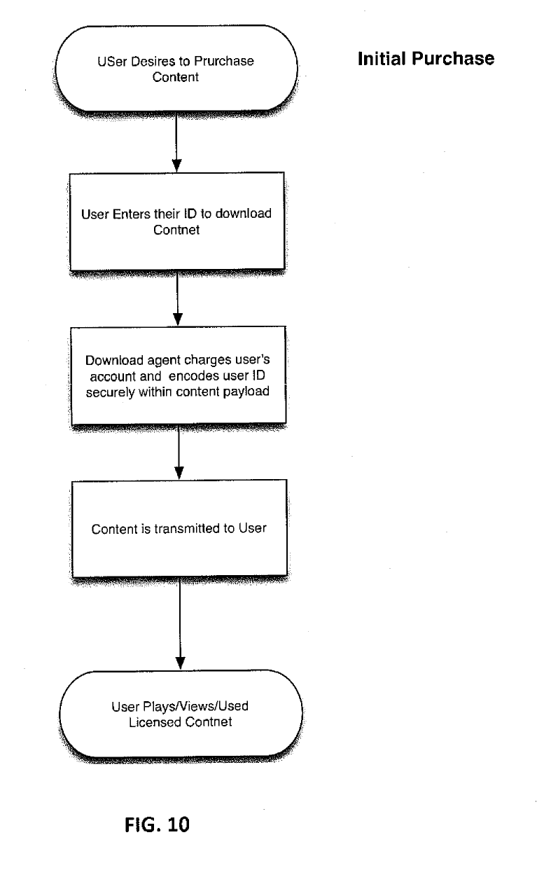

FIG. 10 is a flowchart showing the manner in which digital content is sold. In a first step, the user decides to purchase digital content. The user logs into a digital store either after a selection is made or before browsing for content. The digital content is prepared for download or delivery to the user by encoding the user ID securely within the content. The encoding is typically performed at the content provider using a processor. After the content is encoded, it is delivered. The user is then able to use the digital content.

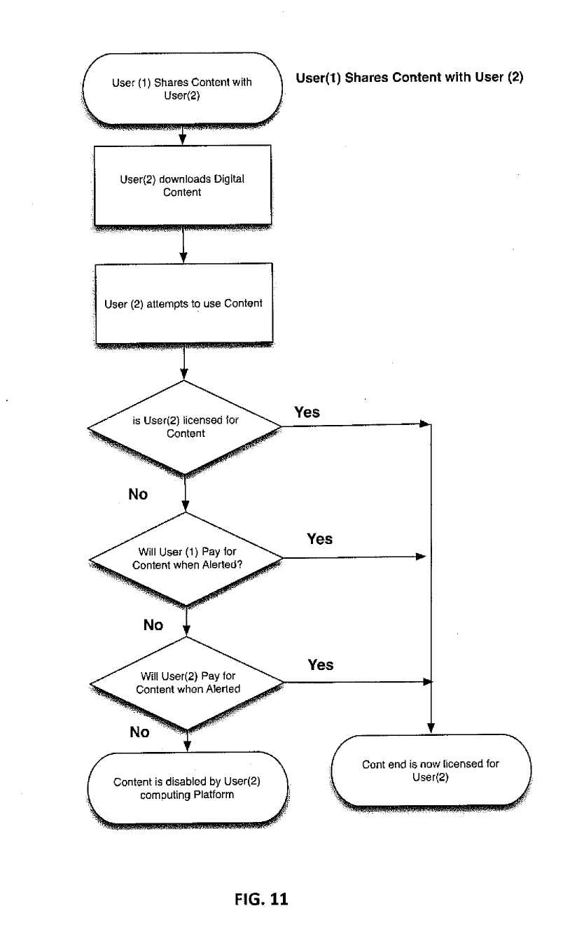

FIG. 11 is a flowchart showing what happens when content is shared between users. A first user shares digital content encoded with a user's ID with a second user. The second user then attempts to use the digital content. The content player checks to determine if the second user has a license for the content. If the user is licensed, the user can access and use the content. If the second user is not authorized, the system determines of the first user is alerted and given the opportunity to authorize the second user or device as an authorized device. If the second user is a new user, the content would have to be paid for. If the first user, the original content owner, will not pay for the content for the second user, the second user is given the opportunity to purchase a license. If a license is not purchased, the digital content is disabled.

In one embodiment, a user purchases a song from a digital content provider such as iTunes. Prior to delivery, the content, for example music, is encoded with a unique user ID, for example the user's Apple ID. If another compatible device, other than the authorized one(s), detects the content, the device sends a message to the content provider, for example Apple, alerting them that a piece of copyrighted content is now in an unlicensed environment. The content provider then can either automatically charge the original license holder a fee for sharing the content or notify the original owners that the content is in an unlicensed environment, giving them the option to pay for it, or alternatively having the content disabled by the unauthorized user's player. It should be noted that if the device is a new device with respect to the authorized user, that device can be added to an approved list of devices.

An advantage of automatically charging the original license holder a fee for sharing the content is that if a content purchaser permits their purchased content become freely accessible via file sharing technology such as bit torrent, at least some users will use devices incorporating this technology, thereby providing incremental revenue to the content provider, and providing disincentive to the content purchaser from allowing their purchased content from getting out on to uncontrolled sharing environments. Even if many people can then consume the content using media players that do not use this technology, and thus the content provider is not paid for such usage, the incremental revenue will still be present and the original purchaser will be penalized for disseminating the content.

For example, if Content Purchaser A buys movie M, then uploads M to a bit torrent site, where it is then downloaded and consumed 1,000,000 times, if only 1% of the downloaders consume it with this technology embedded in their media player, and the distribution fee is $10 for each such use, then A is liable for $100,000, providing potential revenue to the content provider and incentive for A not to do such behavior. However, if A wishes to share M with a close friend or family member they trust not to distribute it further, they can still do so.

A further embodiment will allow the recipient of such content to optionally override the requirement that the original purchaser be charged for the distributed usage and to assume responsibility for the content license fee themselves. This allows a purchaser to share the content, with the understanding that the recipient is to pay for it, but with the backup provision that the original purchaser assumes responsibility if the content remains unlicensed. If the new recipient provides payment information to override payment in this manner, the technology may also optionally embed the new financial responsibility data in the content to replace the original data.

In one embodiment, unowned/unlicensed content is detected. A player, which includes a processor and software stored on a nontransient memory, detects a lack of a license and attaches the users ID (iTunes, Google ID, etc.) to the content. The player then informs the user that the content is unlicensed and gives them the opportunity to pay the licenses fee. By attaching the user's ID to the content, any further sharing of this unlicensed content can easily be tracked back to the original source. The system can either auto charge the sharer of the content or pursuer other legal remedies.

### V. Exemplary Computer System

As described above, devices 102, 110, 120, 130, 150, 202, 210, 230 or any other devices described herein may include software components. Accordingly, these devices may be implemented with one or more computer systems. An example of a computer system 801 is shown in FIG. 8. Computer system 801 represents any single or multi-processor computer. Single-threaded and multi-threaded computers can be used. Unified or distributed memory systems can be used.

Computer system 801 includes one or more processors, such as processor 804. One or more processors 804 can execute software implementing the functionality described above. Each processor 804 is connected to a communication infrastructure 802 (for example, a communications bus, cross-bar, or network). Various software embodiments are described in terms of this exemplary computer system. After reading this description, it will become apparent to a person skilled in the relevant art how to implement the features and functions as described herein using other computer systems and/or computer architectures.

Computer system 801 also includes a main memory 807 which is preferably random access memory (RAM). Computer system 801 may also include a secondary memory 808. Secondary memory 808 may include, for example, a hard disk drive 810 and/or a removable storage drive 812, representing a floppy disk drive, a magnetic tape drive, an optical disk drive, etc. Removable storage drive 812 reads from and/or writes to a removable storage unit 814 in a well-known manner. Removable storage unit 814 represents a floppy disk, magnetic tape, optical disk, etc., which is read by and written to by removable storage drive 812. As will be appreciated, the removable storage unit 814 includes a computer usable storage medium having stored therein computer software and/or data.

In alternative embodiments, secondary memory 808 may include other similar means for allowing computer programs or other instructions to be loaded into computer system 801. Such means can include, for example, a removable storage unit 822 and an interface 820. Examples can include a program cartridge and cartridge interface (such as that found in video game devices), a removable memory chip (such as an EPROM, PROM, or flash memory) and associated socket, and other removable storage units 822 and interfaces 820 which allow software and data to be transferred from the removable storage unit 822 to computer system 801.

In accordance with various embodiments, removable storage device 814 or 822 may take the form of a portable media such as a secure removable media (SRM) which may include legitimizing module or agent for legitimizing stored content. For example, a portable media or SRM may include one or more processors and a storage area, and is able to perform various processes or operations, including security related operations, such as encryption and authentication, to control access to stored data (e.g., reading, writing, updating, etc.) as well as content legitimizing operations described herein. The portable media or SRM may for example be a Secure Memory Card (SMC), Smart Card, Multi Media Card (MMC), Secure Digital (SD), USB Flash Drive (USD), and so forth. As noted above, a SRM may be used to store content and/or other information relating to the content. An example of a portable or removable storage device (e.g., 814 and 822) is discussed below with reference to FIG. 9.

Computer system 801 may also include a communications interface 824. Communications interface 824 allows software and data to be transferred between computer system 801 and external devices via communications path 827. Examples of communications interface 827 include a modem, a network interface (such as Ethernet card), Bluetooth and/or other short-range wireless network modules, etc. Software and data transferred via communications interface 827 are in the form of signals 828 which can be electronic, electromagnetic, and optical or other signals capable of being received by communications interface 824, via communications path 827. Note that communications interface 824 provides a means by which computer system 801 can interface to a network such as the Internet.

The various embodiments can be implemented using software running (that is, executing) in an environment similar to that described above with respect to FIG. 8. In this document, the term “computer program product” is used to generally refer to removable storage units 814 and 822, a hard disk installed in hard disk drive 810, or a signal carrying software over a communication path 827 (wireless link or cable) to communication interface 824. A computer useable medium can include magnetic media, optical media, or other recordable media, or media that transmits a carrier wave or other signal. These computer program products are means for providing software to computer system 801.

Computer programs (also called computer control logic) are stored in main memory 807 and/or secondary memory 808. Computer programs can also be received via communications interface 824. Such computer programs, when executed, enable the computer system 801 to perform the various features as discussed herein. In particular, the computer programs, when executed, enable the processor 804 to perform the various features described herein. Accordingly, such computer programs represent controllers of the computer system 801.

The various embodiments can be implemented as control logic in software, firmware, hardware or any combination thereof. In an embodiment implemented using software, the software may be stored in a computer program product and loaded into computer system 801 using removable storage drive 812, hard drive 810, or interface 820. Alternatively, the computer program product may be downloaded to computer system 801 over communications path 827. The control logic (software), when executed by the one or more processors 804, causes the processor(s) 804 to perform the functions of the various embodiments as described herein.

In another embodiment, the various features and functions maybe implemented primarily in firmware and/or hardware using, for example, hardware components such as application specific integrated circuits (ASICs). Implementation of a hardware state machine so as to perform the functions described herein will be apparent to persons skilled in the relevant art(s).

### VI. Exemplary Portable or Removable Memory

As described above, a portable or removable memory device (e.g., 814, 822) can be used to receive, maintain, store and transfer among other things various data such as content and/or information reflecting that the content is legitimate or authorized, e.g., marking, watermarking, receipt, license number, etc., or computer programs or executable code. An example is shown by removable/portable memory device 900.

As shown, memory device 900 may include one or more processors 902 (e.g., microprocessor(s)), a storage 904 for storing data such as one or more content and other information to implement the functions and operations described herein for legitimizing content after the content has been obtained, and a communications interface(s) 908 for communicating data to and from device 900. The post legitimizing operation may be implemented through a legitimizing module or agent that may take the form of a client software or user application, as noted above. The post legitimizing operation may be implemented through the memory device or through cooperation or interaction with another device, e.g., a computer system, a mobile unit, terminal, kiosk, etc. As with computer system 801, memory device 900 may also perform various functions and operations through execution of computer program or computer executable code and include communications capability (e.g., wireless or wireline) depending on the type of memory, e.g., smart card, flash memory, etc.

### VII. Conclusion

While various embodiments of the present inventions have been described above, it should be understood that they have been presented by way of example only, and not limitation. Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

We claim:

1. A method comprising:
encoding, with a processor, a digital content with a unique identifier;
delivering the digital content to an authorized user;
receiving a query from a second user;
determining if the second user is the authorized user; and
if the user is not an authorized user one of receiving a payment authorization for the digital content and receiving an instruction to disable the content.

2. The method of claim 1, wherein the authorized user preauthorizes payment for the digital content.

3. A method for providing digital content comprising:
encoding a license holder ID for a user within a digital content payload;
checking the license holder ID against an ID associated with a player;
determining an authenticity of a license for the player transmitting unauthorized access attempts to a centralized server; and
charging the user for permitting unauthorized sharing of the digital content,
wherein the user can share the digital content by paying an additional license fees.
